(19) United States
(12) Patent Application Publication
(10) Pub. No.: US 2020/0166980 A1
(43) Pub. Date: May 28, 2020

(54) INTELLIGENT STORAGE DEVICE AND METHOD FOR ACCESSING INTELLIGENT STORAGE DEVICE

(71) Applicant: Norel Systems Limited, Tianjin (CN)

(72) Inventors: Ting WU, TIANJIN (CN); Rui ZHU, TIANJIN (CN); Yuanlong WANG, TIANJIN (CN); Hui WANG, TIANJIN (CN); Lulu XU, TIANJIN (CN); Wei ZHAO, TIANJIN (CN); Meng ZHANG, TIANJIN (CN); Miao CHEN, TIANJIN (CN)

(21) Appl. No.: 16/695,315

(22) Filed: Nov. 26, 2019

(30) Foreign Application Priority Data
Nov. 28, 2018 (CN) 2018114311752
Nov. 30, 2018 (CN) 2018114548096

(51) Int. Cl. G06F 1/26; H02J 7/00

(52) U.S. Cl. CPC G06F 1/266; H02J 7/0052; H02J 2007/0096; H02J 7/0006; H02J 2007/0062; H02J 7/007

(57) ABSTRACT

The present invention disclosed a method for accessing an intelligent storage device, said intelligent storage device includes a first USB interface, a second USB interface, and a storage unit interface. The intelligent storage device is alternatively configured to be in a PC communication mode or a mobile terminal communication mode according to a connection state of the first USB interface. In the PC communication mode, the intelligent storage device conducts USB data communication with the USB host through the first USB interface, and reads and writes the storage unit through the storage unit interface. In the mobile terminal communication mode, the intelligent storage device conducts USB data communication with the mobile terminal device through a second USB interface, and reads and writes the storage unit through the storage unit interface.

### CROSS-REFERENCE TO RELATED PATENT APPLICATION

This non-provisional application claims priority to and the benefit of, pursuant to 35 U.S.C. § 119(a), patent application Serial No. CN 2018114311752 filed in China on Nov. 28, 2018 and CN 2018114548096 filed in China on Nov. 30, 2019. The disclosures of the above applications are incorporated herein in their entireties by reference.

### TECHNICAL FIELD

The present invention relates to the field of electronic accessories and mobile storage technologies, and in particular, to an intelligent storage device and a method for accessing an intelligent storage device.

### BACKGROUND

As the name implies, a mobile storage device is a storage product that includes an internal storage medium and emphasizes portability, and can exchange large-capacity data with a host at a high speed. According to different built-in storage media, it mainly includes a mechanical mobile hard disk, a solid-state mobile hard disk, a USB flash disk, etc.

This kind of mobile storage device generally adopts a USB interface, which is popular because of its advantages of having good compatibility and supporting hot swap. A USB2.0 interface is at a speed of 480 megabits per second (Mbps), and the latest USB3.0 and USB3.1 interfaces increase the interface speed to 5 gigabits per second (Gbps) and 10 gigabits per second (Gbps).

When the capacity of the mobile storage device is large, its operating current is also large. For example, the operating current of the mechanical mobile hard disk or solid-state mobile hard disk can sometimes exceed 1 A, and the operating current of a large-capacity USB flash disk can also reach several hundred milliamps. In the future, the current will increase even more as the capacity increases.

Due to the high operating current, the current mechanical mobile hard disk or solid-state mobile hard disk can generally only be connected to a PC, and data transmission and backup can be performed for the PC through a USB interface. As mobile terminal devices represented by mobile phones are weak in external power supply, and some mobile phones do not even support external power supply, the existing mechanical mobile hard disk or solid-state mobile hard disk cannot be used to back up for the mobile phones. The number and applications of mobile devices, such as mobile phones, have surpassed those of PCs, which hold a large amount of user data. At present, mobile phone backup is mainly through an online cloud disk. In addition to possible charges, the speed of mobile phone backup through wireless connection is also limited by a wireless connection speed. With the continuous improvement of mobile phone storage capacity, it is increasingly difficult to back up mobile phone data.

In addition to the limitation of the supply current, the diversity of USB protocols, USB cables, and interface types also increases the complexity of designing mobile phone backup devices. For example, a USB standard defines a variety of USB interface types, including a USB Type A interface, a USB Micro B interface, and a USB Type C interface commonly used in mobile phones or PCs. Also, each kind of interface includes male and female connectors, a USB cable includes the cable itself and two male connectors at both ends, and the USB standard defines a variety of USB cables, for example, a USB Type A->USB Micro B cable, a USB Type A->USB Type C cable, a USB Type C->Micro USB cable and a USB Type C<->USB Type C cable are commonly used in a mobile phone charger and the mechanical mobile hard disk or solid-state mobile hard disk. A mobile storage device that backs up mobile phones needs to be able to use the common USB cables described above. Otherwise, a device possibly needs to be specially provided with a cable type, which, in addition to increasing the cost, causes trouble in use as most users are not familiar with these uncommon cable types. Being able to back up with common USB cable types is not a simple connection problem, but a difficult design problem. As defined by the USB standard, a USB interface type also defines a power supply direction of a USB interface and whether a USB controller operates in a USB Host mode or a USB Device mode, thus defining a master-slave relationship of data transmission. For example, if a Device has a USB Type A block, then the USB A block can only supply power externally but cannot be powered, and its USB controller can only operate in the USB Host mode but not in the USB Device mode. Thus, a USB cable, because of its connector and the type of socket matched therewith, actually controls the direction of the supply current and the master-slave relationship of USB data transmission.

With the popularity of mobile terminal devices especially smart phones, how to provide users with mobile storage devices, which not only can back up for PCs but also can be convenient, fast and safe to back up data for mobile phones, and at the same time, can also use USB cables such as mobile phone chargers and mobile hard disks, and are compatible with a huge number of different kinds of mobile phones, PCs, and mobile phone chargers on the market, increasingly becomes an urgent problem to be solved.

### SUMMARY

The technical problem to be solved in the present invention is that most mobile storage devices on the market can only be connected to USB hosts represented by PCs for data transmission and backup but cannot be connected to mobile terminal devices, for which the reason is that mobile terminal devices such as mobile phones often cannot provide a sufficient operating current for the mobile storage devices, or the mobile storage devices cannot concisely and effectively be compatible with and support a huge number of different kinds of mobile phones, PCs, and mobile phone chargers.

In order to solve the above technical problem, the present invention adopts the following technical solution.

The present invention provides a method for accessing an intelligent storage device that includes a first USB interface, a second USB interface, and a storage unit interface, wherein

the storage unit interface is connected to a storage unit,

the first USB interface is connected to a USB interface of a USB host or a power adapter through a first USB cable, and a VBUS signal of the first USB interface supplies power for the intelligent storage device and the storage unit,

the intelligent storage device is alternatively configured to be in a PC communication mode or a mobile terminal communication mode according to a connection state of the first USB interface,

the intelligent storage device is configured to be in the PC communication mode when detecting that the first USB interface is connected to the USB host,

in the PC communication mode, the intelligent storage device conducts USB data communication with the USB host through the first USB interface, and reads and writes the storage unit through the storage unit interface, and the first USB interface operates in a USB Device mode,

the intelligent storage device is configured to be in the mobile terminal communication mode when detecting that the first USB interface is connected to the power adapter, and

in the mobile terminal communication mode, the second USB interface is connected to a mobile terminal device through a second USB cable, the intelligent storage device conducts USB data communication with the mobile terminal device through the second USB interface, and reads and writes the storage unit through the storage unit interface.

Preferably, the intelligent storage device disconnects the VBUS signal of the first USB interface from a VBUS signal of the second USB interface when configured to be in the PC communication mode.

Preferably, the intelligent storage device limits a current from the VBUS signal of the first USB interface to the VBUS signal of the second USB interface when configured to be in the PC communication mode.

Preferably, the second USB interface is a USB Type A female connector, and when configured to be in the mobile terminal communication mode, the intelligent storage device connects the VBUS signal of the first USB interface with the VBUS signal of the second USB interface and supplies power for the VBUS signal of the second USB interface, the mobile terminal device conducts USB data communication with the intelligent storage device through the second USB interface, and the second USB interface operates in the USB Host mode.

Further, the second USB interface enumerates the mobile terminal device and identifies the type of the mobile terminal device in the USB Host mode, and when the mobile terminal device is identified as an android device, the second USB interface remains in the USB Host mode and conducts subsequent USB data communication.

Further, the second USB interface enumerates the mobile terminal device and identifies the type of the mobile terminal device in the USB Host mode, and when the mobile terminal device is identified as an apple IOS Device, the second USB interface performs a role switching operation after enumeration, and then operates in the USB Device mode and conducts subsequent USB data communication with the mobile terminal device.

Preferably, the second USB interface is a USB Type C female connector, the intelligent storage device further includes a PD controller, and when the intelligent storage device is configured to be in the mobile terminal communication mode, the PD controller and the mobile terminal device fixedly configure the second USB interface as a power source through CC1 and CC2 signals of the second USB interface according to a PD protocol, and the intelligent storage device connects the VBUS signal of the first USB interface with the VBUS signal of the second USB interface and supplies power for the VBUS signal of the second USB interface.

Preferably, the second USB interface is a USB Type C female connector, the intelligent storage device further includes a PD controller, and when the intelligent storage device is configured to be in the mobile terminal communication mode, the PD controller and the mobile terminal device negotiate through CC1 and CC2 signals of the second USB interface according to a PD protocol, the intelligent storage device alternatively configures the second USB interface as a power source or a power sink according to a negotiation result, when the second USB interface is configured as the power source, the intelligent storage device connects the VBUS signal of the first USB interface with the VBUS signal of the second USB interface and supplies power for the VBUS signal of the second USB interface, and when the second USB interface is configured as the power sink, the intelligent storage device disconnects the VBUS signal of the first USB interface from the VBUS signal of the second USB interface.

Preferably, the second USB interface is a USB Type C female connector, the intelligent storage device further includes a PD controller, and when the intelligent storage device is configured to be in the mobile terminal communication mode, the PD controller and the mobile terminal device fixedly configure the second USB interface to be in a USB host mode through CC1 and CC2 signals of the second USB interface according to a PD protocol and conduct USB data communication with the mobile terminal device.

Further, the second USB interface enumerates the mobile terminal device and identifies the type of the mobile terminal device in the USB Host mode, and when the mobile terminal device is identified as an android device, the second USB interface remains in the USB Host mode and conducts subsequent USB data communication with the mobile terminal device.

Further, the second USB interface enumerates the mobile terminal device and identifies the type of the mobile terminal device in the USB Host mode, and when the mobile terminal device is identified as an apple IOS Device, the second USB interface performs a role switching operation after enumeration, and then operates in the USB Device mode and conducts subsequent USB data communication with the mobile terminal device.

Preferably, the second USB interface is a USB Type C female connector, the intelligent storage device further includes a PD controller, and when the intelligent storage device is configured to be in the mobile terminal communication mode, the PD controller and the mobile terminal device negotiate through CC1 and CC2 signals of the second USB interface according to a PD protocol, and the intelligent storage device alternatively configures the second USB interface to be in a USB Host mode or USB Device mode according to a negotiation result and conduct USB data communication with the mobile terminal device.

Further, when the second USB interface is configured to be in the USB Host mode, the second USB interface enumerates the mobile terminal device and identifies the type of the mobile terminal device in the USB Host mode, and when the mobile terminal device is identified as an android device, the second USB interface remains in the USB Host mode and conducts subsequent USB data communication with the mobile terminal device.

Further, when the second USB interface is configured to be in the USB Host mode, the second USB interface enumerates the mobile terminal device and identifies the type of the mobile terminal device in the USB Host mode, and when the mobile terminal device is identified as an apple IOS Device, the second USB interface performs a role switching operation after enumeration, and then operates in the USB Device mode and conducts subsequent USB data communication with the mobile terminal device.

Preferably, the intelligent storage device detects the voltage of the VBUS signal of the first USB interface, and when the intelligent storage device is configured to be in the mobile terminal communication mode and the VBUS signal of the first USB interface is connected to the VBUS signal of the second USB interface, the intelligent storage device limits the current from the first USB interface to the VBUS signal of the second USB interface if the voltage is lower than a preset voltage value.

Preferably, the intelligent storage device detects the current of the VBUS signal of the first USB interface, and when the intelligent storage device is configured to be in the mobile terminal communication mode and the VBUS signal of the first USB interface is connected to the VBUS signal of the second USB interface, the intelligent storage device limits the current from the first USB interface to the VBUS signal of the second USB interface if the current is higher than a preset current value.

Preferably, the first USB interface operates in the USB Device mode and attempts to conduct a USB data connection with a device connected to the first USB interface, if the connection is successful within a preset time, the first USB interface is connected to the USB host, and if the connection is unsuccessful, the first USB interface is connected to the power adapter.

Preferably, the intelligent storage device further includes a USB interface type detection module that detects, according to a Battery Charging Specification, whether the device connected to the first USB interface is a USB host or a power adapter.

Preferably, when detecting that the device connected to the first USB interface is the power adapter, the USB interface type detection module further detects a maximum supply current of the power adapter according to the Battery Charging Specification, and when the maximum supply current of the power adapter is lower than a preset value, the intelligent storage device limits the current from the VBUS signal of the first USB interface to the VBUS signal of the second USB interface.

Preferably, the storage unit interface is an SATA interface, a PCIe interface, an SD interface, an MMC interface, a UFS interface, a Toggle NAND Flash interface, or an ONFI NAND Flash interface.

Preferably, the first USB interface is a USB Micro B female connector or USB Type C female connector.

The present invention has the following beneficial effects. Through automatic identification of a connection state of USB interfaces in the intelligent storage device, the intelligent storage device can switch between a PC communication mode and a mobile terminal communication mode, which not only ensures that it can conduct USB data communication with a USB host represented by a PC but also can conduct data communication with a mobile terminal device when it is connected to a mobile phone charger to supply power as a power adapter. In the present invention, a mobile phone charging line, a mobile hard disk USB line, or other common USB cables, are used to be compatible with various types of mobile terminal devices (including android devices and apple IOS devices), and at the same time, with the method of low-voltage detection or over-current detection on a power signal input by the intelligent storage device, the intelligent storage device is controlled to limit or disconnect the power supply to the mobile terminal device, thus ensuring the stability of data transmission when a normal mobile phone charger is used as a power adapter, and improving the compatibility and reliability of the intelligent storage device.

### BRIEF DESCRIPTION OF DRAWINGS

The present invention is further described below with reference to the accompanying drawings and embodiments.

FIG. 1 is a module diagram and schematic application diagram of an embodiment of an intelligent storage device according to the present invention.

FIG. 2 is a schematic diagram of direct connection of a power supply detection module in an intelligent storage device according to the present invention.

FIG. 3 is a schematic diagram of a power supply detection module including a low-voltage detection module in an intelligent storage device according to the present invention.

FIG. 4 is a schematic diagram of a power supply detection module including an over-current detection module in an intelligent storage device according to the present invention.

FIG. 5 is a schematic diagram of a first implementation method for a power supply control module including a current limiter and a switch in an intelligent storage device according to the present invention.

FIG. 6 is a schematic diagram of a second implementation method for a power supply control module including a current limiter and a switch in an intelligent storage device according to the present invention.

In the drawings,

```
  1 intelligent storage device
  11 first USB interface
  12 second USB interface
  21 USB host, or power adapter
  22 mobile terminal device
  31 first USB cable
  32 second USB cable
  5 microcontroller unit
  51 first USB controller
  52 second USB controller
  53 storage controller
511 USB interface type detection module
  54 storage unit interface
541 PD controller
  7 power supply control module
  71 power supply control module input end
  72 power supply control module output end
  73 power supply control module selection end
  74 current limiter
  75 first switch
  76 second switch
  77 third switch
  78 fourth switch
  8 power supply detection module
  81 power supply detection module input end
  82 power supply detection module output end
  83 power supply detection module state end
  84 low-voltage detection module
  85 over-current detection module
  61 power supply control signal
  62 power supply detection state signal
  63 device power signal
  9 storage unit
```

### DESCRIPTION OF EMBODIMENTS

An intelligent storage device and a method for accessing an intelligent storage device in the present invention are further described below in combination with embodiments in the drawings.

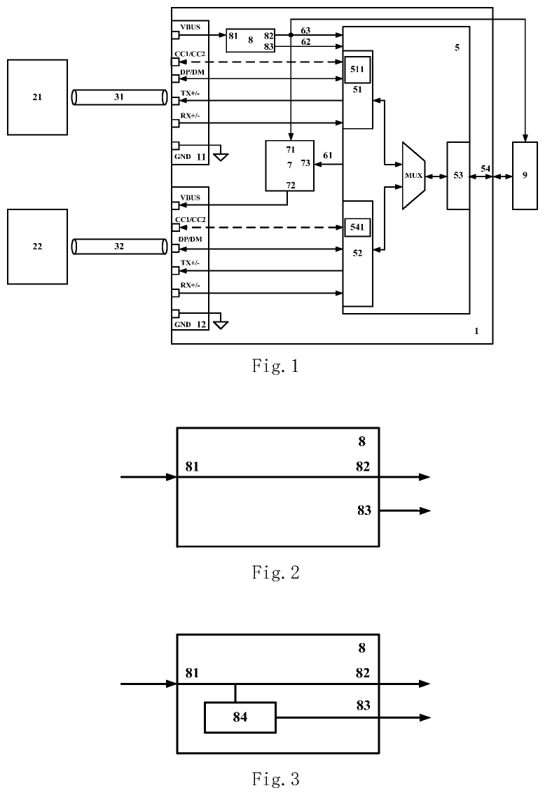

FIG. 1 shows a first embodiment of an intelligent storage device according to the present invention. In this embodiment, the intelligent storage device 1 includes a first USB interface 11, a second USB interface 12, and a storage unit interface 54. The intelligent storage device 1 further includes a microcontroller unit 5, a power supply control module 7, and a power supply detection module 8.

The storage unit interface 54 is connected to a storage unit 9.

The microcontroller unit 5 includes a first USB controller 51, a second USB controller 52, and a storage controller 53. The microcontroller unit 5 reads and writes the storage unit 9 through the storage controller 53 and the storage unit interface 54 connected thereto.

DP and DM signals or DP and DM and TX+/− and RX+/− signals of the first USB interface 11 are connected to the first USB controller 51.

DP and DM signals or DP and DM and TX+/− and RX+/− signals of the second USB interface 12 are connected to the second USB controller 52.

The DP and DM signals are bidirectional data differential signals defined by a USB2.0 protocol, while the TX+/− and RX+/− signals are respectively sent data differential signals and received data differential signals defined by a USB3.0 protocol.

The first USB interface 11 may be a USB Micro B female connector or USB Type C female connector. When the first USB interface 11 is the USB Type C female connector, the first USB interface 11 further includes CC1 and CC2 signals, and a connection between the CC1 and CC2 signals of the first USB interface 11 and the first USB controller 51 as shown by the dotted line in FIG. 1 exists.

When the first USB interface 11 is the USB Micro B female connector, the first USB interface 11 does not include the CC1 and CC2 signals. The connection between the CC1 and CC2 signals of the first USB interface 11 and the first USB controller 51 as shown by the dotted line in FIG. 1 does not exist.

The second USB interface 12 may be a USB Type A female connector or USB Type C female connector. When the second USB interface 12 is the USB Type C female connector, the second USB interface 12 further includes CC1 and CC2 signals, and a connection between the CC1 and CC2 signals of the second USB interface 12 and the second USB controller 52 as shown by the dotted line in FIG. 1 exists.

When the second USB interface 12 is the USB Type A female connector, the second USB interface 12 does not include the CC1 and CC2 signals. The connection between the CC1 and CC2 signals of the second USB interface 12 and the second USB controller 52 as shown by the dotted line in FIG. 1 does not exist.

The power supply control module 7 includes a power supply control module input end 71, a power supply control module output end 72, and a power supply control module selection end 73.

The power supply control module 7 may implement connection and disconnection between the power supply control module input end 71 and the power supply control module output end 72 under the control of the power supply control module selection end 73. Further, the power supply control module input end 71 and the power supply control module output end 72 may be directly connected or connected through a current limiter 74. When they are directly connected, the current between the power supply control module input end 71 and the power supply control module output end 72 is not limited. When they are connected through the current limiter 74, the current between the power supply control module input end 71 and the power supply control module output end 72 is limited.

FIG. 5 shows an embodiment of the power supply control module 7. The power supply control module 7 includes a current limiter 74, and further includes a first switch 75 and a second switch 76. Their connection relationship is as shown in FIG. 5. When the first switch 75 is switched off, the power supply control module input end 71 is disconnected from the power supply control module output end 72. When the first switch 75 and the second switch 76 are switched on simultaneously, the power supply control module input end 71 is directly connected to the power supply control module output end 72. When the first switch 75 is switched on and the second switch 76 are switched off, the power supply control module input end 71 is connected to the power supply control module output end 72 through the current limiter 74.

FIG. 6 shows another embodiment of the power supply control module 7. The power supply control module 7 includes a current limiter 74, and further includes a third switch 77 and a fourth switch 78. Their connection relationship is as shown in FIG. 6. When the third switch 77 and the fourth switch 78 are switched off simultaneously, the power supply control module input end 71 is disconnected from the power supply control module output end 72. When the fourth switch 78 is switched on, the power supply control module input end 71 is directly connected to the power supply control module output end 72. When the third switch 77 is switched on and the fourth switch 78 is switched off, the power supply control module input end 71 is connected to the power supply control module output end 72 through the current limiter 74.

The current limiter 74 may be an integrated circuit current-limiting chip, or simply a resistor.

The power supply detection module 8 includes a power supply detection module input end 81 and a power supply detection module output end 82, and may also include a power supply detection module state end 83.

FIG. 2 shows an embodiment of the power supply detection module 8, which simply provides a direct connection from the power supply detection module input end 81 to the power supply detection module output end 82. In this case, the power supply detection module state end 83 does not need to be connected.

FIG. 3 shows another embodiment of the power supply detection module 8. The power supply detection module 8 may include a low-voltage detection module 84. The low-voltage detection module 84 is connected to the power supply detection module input end 81, detects whether the voltage of the power supply detection module input end 81 is lower than a preset voltage value, generates a detection state signal, and outputs it to the power supply detection module state end 83.

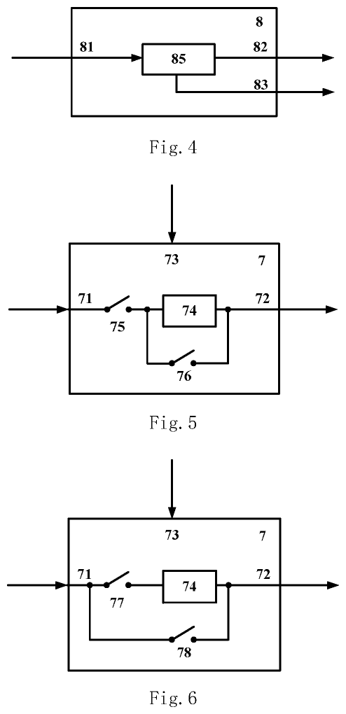

FIG. 4 shows yet another embodiment of the power supply detection module 8. The power supply detection module 8 may include an over-current detection module 85. An input end of the over-current detection module 85 is connected to the power supply detection module input end 81, an output end of the over-current detection module 85 is connected to the power supply detection module output end 82, and the over-current detection module 85 detects whether the current passing through it is higher than a preset current value, generates a detection state signal, and outputs it to the power supply detection module state end 83.

The power supply detection module input end 81 is connected to the power supply detection module output end 82 all the time, and they may be directly connected as shown in FIG. 2 and FIG. 3 or connected through the over-current detection module 85 shown in FIG. 4. During implementation, the over-current detection module 85 generally neither has a large internal resistance nor generates a large voltage drop.

The first USB interface 11 is connected to a USB host 21 or a power adapter 21 through a first USB cable 31. The USB host 21 may be a PC or the like. The power adapter 21 may be a mobile phone charger, a power bank, or the like.

The USB host or the power adapter supplies power for the VBUS signal of the first USB interface. The VBUS signal of the first USB interface 11 is connected to the power supply detection module input end 81, the power supply detection module input end 81 is connected to the power supply detection module output end 82, the power supply detection module output end 82 is connected to a device power signal 63, the device power signal 63 is connected to the microcontroller unit 5 and the storage unit 9 and supplies power for the microcontroller unit 5 and the storage unit 9, the power supply detection module state end 83 is connected to a power supply detection state signal 62, and the power supply detection state signal 62 is connected to the microcontroller unit 5.

The device power signal 63 is further connected to the power supply control module input end 71, the power supply control module output end 72 is connected to the VBUS signal of the second USB interface 12, the power supply control module selection end 73 is connected to a power supply control signal 61, and the power supply control signal 61 is connected to the microcontroller unit 5.

As can be seen from the above, the USB host or the power adapter supplies power for the intelligent storage device 1 and the storage unit 9 through the VBUS signal of the first USB interface 11.

The microcontroller unit 5 alternatively configures the intelligent storage device 1 to be in a PC communication mode or a mobile terminal communication mode according to a connection state of the first USB interface 11.

The microcontroller unit 5 detects through the first USB controller 51 whether the first USB interface 11 is connected to the USB host 21 or the power adapter 21. The USB host 21 is capable of USB data communication in the USB Host mode, while the power adapter 21 is incapable of USB data communication.

A method for detecting whether the first USB interface 11 is connected to the USB host 21 or the power adapter 21 is as follows. The first USB controller 51 operates in the USB Device mode and attempts to conduct a USB data connection with a device connected to the first USB interface 11 according to the definition of the USB standard, if the connection is successful within a preset time, the first USB interface 11 is connected to the USB host 21, and if the connection is unsuccessful, the first USB interface 11 is connected to the power adapter 21.

The first USB controller 51 may further include a USB interface type detection module 511, and the USB interface type detection module 511 is connected to the DP and DM signals of the first USB interface 11.

The USB standard has defined a Battery Charging Specification for DP and DM. Samsung, Apple, Huawei and other companies have also defined their Battery Charging Specifications for DP and DM. The Battery Charging Specifications distinguish whether a USB device is only capable of supplying power or also capable of USB data communication in the USB Host mode.

Another method for detecting whether the first USB interface 11 is connected to the USB host 21 or the power adapter 21 is as follows. The USB interface type detection module 511 detects, through the DP and DM signals according to the Battery Charging Specification, whether the device connected to the first USB interface 11 is the power adapter 21 only capable of supplying power or the USB host 21 also capable of USB data communication in the USB Host mode.

According to the USB standard, the USB Micro B female connector is a power sink. When the first USB interface 11 is the USB Micro B female connector, the VBUS signal of the first USB interface 11 accepts the power supply from the USB host 21 or the power adapter 21 externally connected.

When the first USB interface 11 is a USB Type C female connector, it further includes CC1 and CC2 signals, and the USB interface type detection module 511 is connected to the CC1 and CC2 signals of the first USB interface 11.

The USB standard has defined a USB Power Delivery Specification, referred to as a PD protocol, for CC1 and CC2. The PD protocol is also one kind of Battery Charging Specification. According to the PD protocol, the USB Type C female connector may be a power source or power sink. The PD protocol also distinguishes whether a USB device is only capable of supplying power or also capable of USB data communication and whether it operates in the USB Host mode or USB Device mode when it is capable of USB data communication.

When the first USB interface 11 is a USB Type C female connector, another method for detecting whether the first USB interface 11 is connected to the USB host 21 or the power adapter 21 is as follows. The USB interface type detection module 511 fixedly configures the first USB interface 11 as a power sink and to be in the USB Device mode through the CC1 and CC2 signals according to the PD protocol, and the USB interface type detection module 511 detects, through the CC1 and CC2 signals according to the PD protocol, whether the device connected to the first USB interface 11 is the power adapter 21 only capable of supplying power or the USB host 21 also capable of USB data communication in the USB Host mode.

The Battery Charging Specification further defines a method for a power supply device to report its maximum supply current, and a powered device may detect the maximum supply current of the power supply device through the Battery Charging Specification.

When detecting through the first USB controller 51 that the first USB interface 11 is connected to the USB host 21, the microcontroller unit 5 configures the intelligent storage device 1 to be in the PC communication mode.

In the PC communication mode, the intelligent storage device 1 conducts USB data communication with the USB host 21 through the first USB controller 51, and reads and writes the storage unit 9 through the storage controller 53 and the storage unit interface 54 connected thereto. The first USB controller 51 operates in the USB Device mode.

In the PC communication mode, the microcontroller unit 5 may control the power supply control module 7 through the power supply control signal 61 to disconnect the power supply control module input end 71 from the power supply control module output end 72 so as not to supply power for the VBUS signal of the second USB interface 12.

In the PC communication mode, the microcontroller unit 5 may also control the power supply control module 7 through the power supply control signal 61 to connect the power supply control module input end 71 with the power supply control module output end 72 through the current limiter 74 to limit a supply current to the VBUS signal of the second USB interface 12.

In the PC communication mode, the USB host 21 supplies power for the intelligent storage device 1 through the VBUS signal of the first USB interface 11, and conducts USB data communication therewith to write and read the storage unit 9. As the USB host 21 is usually weak in power supply capability in the case of USB data communication, for example, its maximum power supply capability in the case of USB data communication in an SDP mode defined by the USB standard is 500 mA, although the USB host 21 may generally increase the maximum current value to more than 500 mA in actual implementation, not supplying power for the VBUS signal of the second USB interface 12 or limiting the supply current to the VBUS signal of the second USB interface 12 in the PC communication mode may reduce power consumption to lower than the maximum supply current value of the USB host 21, improving the compatibility.

When detecting through the first USB controller 51 that the first USB interface 11 is connected to the power adapter 21, the microcontroller unit 5 configures the intelligent storage device 1 to be in the mobile terminal communication mode.

In the mobile terminal communication mode, the microcontroller unit 5 controls the power supply control module 7 through the power supply control signal 61 to connect or disconnect the power supply control module input end 71 with or from the power supply control module output end 72, the second USB interface 12 is connected to a mobile terminal device 22 through a second USB cable 32, and the intelligent storage device 1 conducts USB data communication with the mobile terminal device 22 through the second USB controller 52, and reads and writes the storage unit 9 through the storage controller 53 and the storage unit interface 54 connected thereto.

The second USB interface 12 may be a USB Type A female connector or USB Type C female connector. When the second USB interface 12 is the USB Type A female connector and the intelligent storage device 1 is configured to be in the mobile terminal communication mode, the microcontroller unit 5 controls the power supply control module 7 through the power supply control signal 61 to connect the power supply control module input end 71 with the power supply control module output end 72 to supply power for the VBUS signal of the second USB interface 12, the mobile terminal device 22 conducts USB data communication with the intelligent storage device 1 through the second USB controller 52, and the second USB controller 52 operates in the USB Host mode. The second USB controller 52 enumerates the mobile terminal device 22 and identifies the type of the mobile terminal device 22 in the USB Host mode, and when the mobile terminal device 22 is identified as an android device, the second USB controller 52 remains in the USB Host mode and conducts subsequent USB data communication through, but not limited to, an Android Open Accessory Protocol (AOA protocol). When the mobile terminal device 22 is identified as an apple IOS Device, the second USB controller 52 performs a role switching operation after enumeration, and then operates in the USB Device mode and conducts subsequent USB data communication with the mobile terminal device 22. The role switching method is defined by an apple MFi protocol.

The second USB controller 52 enumerates the mobile terminal device 22 in the USB Host mode, and identifies whether the mobile terminal device 22 is an android device or an apple IOS Device by reading and identifying VID, or VID and PID of the mobile terminal device 22.

The AOA protocol is a protocol launched by Google Inc. for USB communication between android devices and peripherals, which expands functions of USB interfaces of the android devices and provides conditions for applying android-system-based intelligent devices to the field of data transmission and device control.

A Made for iPhone/iPod/iPad protocol (MFi protocol) is a set of protocols launched by Apple Inc. to allow authorized manufacturers to print an authorized label (MFi authorized logo) on the product packaging, which has strict rules on product certification, thus ensuring the compatibility between MFi-certified devices to the maximum extent.

When the second USB interface 12 is the USB Type C female connector, the second USB controller 52 further includes a PD controller 541 connected to CC1 and CC2 signals of the USB Type C female connector.

When the intelligent storage device 1 is configured to be in the mobile terminal communication mode, the second USB interface 12 may only be a power source, and the PD controller 541 and the mobile terminal device 22 may fixedly configure the second USB interface 12 as the power source through the CC1 and CC2 signals according to the PD protocol; or the second USB interface 12 may be either a power source or a power sink, the PD controller 541 and the mobile terminal device 22 negotiate through the CC1 and CC2 signals according to the PD protocol, and the intelligent storage device 1 alternatively configures the second USB interface 12 as a power source or a power sink according to a negotiation result between the PD controller 541 and the mobile terminal device 22. When the second USB interface 12 is configured as the power source, the microcontroller unit 5 controls the power supply control module 7 through the power supply control signal 61 to connect the power supply control module input end 71 with the power supply control module output end 72 to supply power for the VBUS signal of the second USB interface 12. When the second USB interface 12 is configured as the power sink, the microcontroller unit 5 controls the power supply control module 7 through the power supply control signal 61 to disconnect the power supply control module input end 71 from the power supply control module output end 72.

Moreover, when the intelligent storage device 1 is configured to be in the mobile terminal communication mode, the second USB interface 12 may only support the USB Host mode, and the PD controller 541 and the mobile terminal device 22 fixedly configure the second USB interface 12 to be in the USB Host mode through the CC1 and CC2 signals according to the PD protocol and conduct data communication with the mobile terminal device 22; or the second USB interface 12 may support both the USB Host mode and the USB Device mode, the PD controller 541 and the mobile terminal device 22 negotiate through the CC1 and CC2 signals according to the PD protocol, and the intelligent storage device 1 alternatively configures the second USB interface 12 to be in the USB Host mode or USB Device mode according to a negotiation result between the PD controller 541 and the mobile terminal device 22. When the second USB interface 12 is configured to be in the USB Host mode, the second USB controller 52 enumerates the mobile terminal device 22 and identifies the type of the mobile terminal device 22 in the USB Host mode, and when the mobile terminal device 22 is identified as an android device, the second USB controller 52 remains in the USB Host mode and conducts subsequent USB data communication through, but not limited to, an AOA protocol. When the mobile terminal device 22 is identified as an apple IOS Device, the second USB controller 52 performs a role switching operation after enumeration, and then operates in the USB Device mode and conducts subsequent USB data communication with the mobile terminal device 22. The role switching method is defined by an apple MFi protocol.

The second USB controller 52 enumerates the mobile terminal device 22 in the USB Host mode, and identifies whether the mobile terminal device 22 is an android device or an apple IOS Device by reading and identifying VID, or VID and PID of the mobile terminal device 22.

The PD controller 52 may implement complete functions defined by the PD protocol, as well as partial functions defined by the PD protocol. In particular, the PD controller 541 may simply connect CC1 and CC2 to a specific voltage fixedly according to the PD protocol through a resistor to implement a fixed function. The implementation of the PD controller 541 should enable the second USB interface 12 to be configured at least as the power source and to be in the USB Host mode.

In this embodiment, the VBUS signal of the first USB interface 11 is connected to the power supply detection module input end 81. In the embodiment of the power supply detection module 8 as shown in FIG. 3, the power supply detection module 8 includes a low-voltage detection module 84. The low-voltage detection module 84 is connected to the power supply detection module input end 81, detects whether the voltage of the power supply detection module input end 81 is lower than a preset voltage value, generates a detection state signal, and outputs it to the power supply detection module state end 83. The power supply detection module state end 83 is connected to a power supply detection state signal 62 that is connected to the microcontroller unit 5. When the intelligent storage device 1 is configured to be in the mobile terminal communication mode and the microcontroller unit 5 controls the power supply control module 7 through the power supply control signal 61 to connect the power supply control module input end 71 with the power supply control module output end 72 and when the microcontroller unit 5 knows through the power supply detection state signal 62 that the low-voltage detection module 84 detects the voltage of the power supply detection module input end 81 is lower than a preset voltage value, the microcontroller unit 5 controls the power supply control module 7 through the power supply control signal 61 to connect the power supply control module input end 71 with the power supply control module output end 72 through the current limiter to limit the current from the power supply control module input end 71 to the power supply control module output end 72.

In another embodiment of the power supply detection module 8 as shown in FIG. 4, the power supply detection module 8 includes an over-current detection module 85. An input end of the over-current detection module 85 is connected to the power supply detection module input end 81, an output end of the over-current detection module 85 is connected to the power supply detection module output end 82, the over-current detection module 85 detects whether the current passing through it is higher than a preset current value, generates a detection state signal, and outputs it to the power supply detection module state end 83, the power supply detection module state end 83 is connected to the power supply detection state signal 62, and the power supply detection state signal 62 is connected to the microcontroller unit 5. When the intelligent storage device 1 is configured to be in the mobile terminal communication mode and the microcontroller unit 5 controls the power supply control module 7 through the power supply control signal 61 to connect the power supply control module input end 71 with the power supply control module output end 72 and when the microcontroller unit 5 knows through the power supply detection state signal 62 that the low-voltage detection module 84 detects the value of the current passing through it is higher than a preset current value, the microcontroller unit 5 controls the power supply control module 7 through the power supply control signal 61 to connect the power supply control module input end 71 with the power supply control module output end 72 through the current limiter to limit the current from the power supply control module input end 71 to the power supply control module output end 72.

The power supply detection module 8 limits the current from the power supply control module input end 71 to the power supply control module output end 72 when detecting a low-voltage or over-current state, thus limiting the current from the VBUS signal of the first USB interface 11 to the VBUS signal of the second USB interface 12, and when the power supply capacity of the connected power adapter 21 is insufficient to supply both the intelligent storage device 1 and the mobile terminal device 22, it can limit the supply current to the mobile terminal device 22, preferentially ensuring supplying power to the intelligent storage device 1 and ensuring the normal operation of data transmission between the intelligent storage device 1 and the mobile terminal device 22. Since the mobile terminal device 22, such as a mobile phone, usually has its own batteries, limiting the supply current to the mobile terminal device 22 is equivalent to only reducing the charging current to the mobile terminal device 22, which will not affect the data transmission between intelligent storage device 1 and the mobile terminal device 22.

In this embodiment, the storage unit interface 54 is an SATA interface, a PCIe interface, an SD (Secure Digital) interface, an MMC (Multimedia Card) interface, a UFS interface, a Toggle NAND Flash interface, an ONFI NAND Flash interface or other storage device interfaces.

In this embodiment, the storage unit 9 may be a mechanical hard disk, a solid-state hard disk, a flash memory chip, a flash memory card, or the like.

In this embodiment, when USB data transmission is performed in the PC communication mode, the first USB controller 51 operates in the USB Device mode, and the second USB controller 52 may not perform USB data transmission. In the mobile terminal communication mode, the first USB controller 51 does not perform USB data transmission, while the second USB controller 52 may operate in the USB Host mode or USB Device mode. In the implementation, the first USB controller 51 and the second USB controller 52 may choose to use the same USB Device mode function module by time sharing, thus saving costs.

In this embodiment, when detecting that the device connected to the first USB interface 11 is the power adapter 21, the USB interface type detection module 511 further detects the maximum supply current of the power adapter 21 according to the Battery Charging Specification. When the maximum supply current of the power adapter 21 is lower than a preset value, the microcontroller unit 5 controls the power supply control module 7 through the power supply control signal 61 to connect the power supply control module input end 71 with the power supply control module output end 72 through the current limiter 74 to limit the current to the VBUS signal of the second USB interface 12.

The USB interface type detection module 511 may detect the maximum supply current of the power adapter 21 through the DP and DM signals of the first USB interface 11 according to the Battery Charging Specification. When the first USB interface 11 is a USB Type C female connector, the USB interface type detection module 511 may also detect the maximum supply current of the power adapter 21 through the CC1 and CC2 signals of the first USB interface 11 according to the PD protocol. The PD protocol is one kind of Battery Charging Specification.

An implementation method for accessing an intelligent storage device according to the present invention is described below with reference to the above embodiments. In the implementation method, the intelligent storage device 1 includes a first USB interface 11, a second USB interface 12, and a storage unit interface 54.

The storage unit interface 54 is connected to a storage unit 9.

The first USB interface 11 is connected to a USB interface of a USB host 21 or a power adapter 21 through a first USB cable 31. A VBUS signal of the first USB interface 11 supplies power for the intelligent storage device 1 and the storage unit 9.

The intelligent storage device 1 alternatively configures the intelligent storage device 1 to be in a PC communication mode or a mobile terminal communication mode according to a connection state of the first USB interface 11.

When detecting that the first USB interface 11 is connected to the USB host 21, the intelligent storage device 1 is configured to be in the PC communication mode.

In the PC communication mode, the intelligent storage device 1 conducts USB data communication with the USB host 21 through the first USB interface 11, and reads and writes the storage unit 9 through the storage unit interface 54, and the first USB interface 11 operates in a USB Device mode.

When detecting that the first USB interface 11 is connected to the power adapter 21, the intelligent storage device 1 is configured to be in the mobile terminal communication mode.

In the mobile terminal communication mode, the second USB interface 12 is connected to a mobile terminal device 22 through a second USB cable 32, and the intelligent storage device 1 conducts USB data communication with the mobile terminal device 22 through the second USB interface 12, and reads and writes the storage unit 9 through the storage unit interface 54.

In the implementation method, the first USB interface 11 may be a USB Micro B female connector or USB Type C female connector. When the first USB interface 11 is the USB Type C female connector, the first USB interface 11 further includes CC1 and CC2 signals. When the first USB interface 11 is the USB Micro B female connector, the first USB interface 11 does not include the CC1 and CC2 signals.

The second USB interface 12 may be a USB Type A female connector or USB Type C female connector. When the second USB interface 12 is the USB Type C female connector, the second USB interface 12 further includes CC1 and CC2 signals. When the second USB interface 12 is the USB Type A female connector, the second USB interface 12 does not include the CC1 and CC2 signals.

In the implementation method, when configured to be in the PC communication mode, the intelligent storage device 1 may disconnect the VBUS signal of the first USB interface 11 from the VBUS signal of the second USB interface 12, and the intelligent storage device 1 may also limit the current from the VBUS signal of the first USB interface 11 to the VBUS signal of the second USB interface 12.

In the implementation method, the second USB interface 12 may be a USB Type A female connector, and when configured to be in the mobile terminal communication mode, the intelligent storage device 1 connects the VBUS signal of the first USB interface 11 with the VBUS signal of the second USB interface 12 and supplies power for the VBUS signal of the second USB interface 12, the mobile terminal device 22 conducts USB data communication with the intelligent storage device 1 through the second USB interface 12, and the second USB interface 12 operates in the USB Host mode.

The second USB interface 12 enumerates the mobile terminal device 22 and identifies the type of the mobile terminal device in the USB Host mode, and when the mobile terminal device 22 is identified as an android device, the second USB interface 12 remains in the USB Host mode and conducts subsequent USB data communication. When the mobile terminal device 22 is identified as an apple IOS Device, the second USB interface 12 performs a role switching operation after enumeration, and then operates in the USB Device mode and conducts subsequent USB data communication with the mobile terminal device 22.

In the implementation method, the second USB interface 12 may be a USB Type C female connector, the intelligent storage device 1 further includes a PD controller 541, and when the intelligent storage device 1 is configured to be in the mobile terminal communication mode, the PD controller 541 and the mobile terminal device 22 fixedly configure the second USB interface 12 as a power source through CC1 and CC2 signals of the second USB interface 12 according to a PD protocol; at this time, the intelligent storage device 1 connects the VBUS signal of the first USB interface 11 with the VBUS signal of the second USB interface 12 and supplies power for the VBUS signal of the second USB interface 12. The PD controller 541 and the mobile terminal device 22 may also negotiate through the CC1 and CC2 signals of the second USB interface 12 according to the PD protocol, and the intelligent storage device 1 alternatively configures the second USB interface 12 as a power source or a power sink according to a negotiation result. When the second USB interface 12 is configured as the power source, the intelligent storage device 1 connects the VBUS signal of the first USB interface 11 with the VBUS signal of the second USB interface 12 and supplies power for the VBUS signal of the second USB interface 12. When the second USB interface 12 is configured as the power sink, the intelligent storage device 1 disconnects the VBUS signal of the first USB interface 11 from the VBUS signal of the second USB interface 12.

In the implementation method, when the intelligent storage device 1 is configured to be in the mobile terminal communication mode, the PD controller 541 and the mobile terminal device 22 may fixedly configure the second USB interface 12 to be in the USB Host mode through CC1 and CC2 signals of the second USB interface 12 according to the PD protocol and conduct USB data communication with the mobile terminal device 22.

When the second USB interface 12 enumerates the mobile terminal device 22 and identifies the type of the mobile terminal device in the USB Host mode, and when the mobile terminal device 22 is identified as an android device, the second USB interface 12 remains in the USB Host mode and conducts subsequent USB data communication with the mobile terminal device 22. When the mobile terminal device 22 is identified as an apple IOS Device, the second USB interface 12 performs a role switching operation after enumeration, and then operates in the USB Device mode and conducts subsequent USB data communication with the mobile terminal device 22.

When the intelligent storage device 1 is configured to be in the mobile terminal communication mode, the PD controller 541 and the mobile terminal device 22 may also negotiate through the CC1 and CC2 signals of the second USB interface 12 according to the PD protocol, and the intelligent storage device 1 alternatively configures the second USB interface 12 to be in the USB Host mode or USB Device mode according to a negotiation result and conduct USB data communication with the mobile terminal device 22.

When configured to be in the USB Host mode, the second USB interface 12 enumerates the mobile terminal device 22 and identifies the type of the mobile terminal device in the USB Host mode. When the mobile terminal device 22 is identified as an android device, the second USB interface 12 remains in the USB Host mode and conducts subsequent USB data communication with the mobile terminal device 22. When the mobile terminal device 22 is identified as an apple IOS Device, the second USB interface 12 performs a role switching operation after enumeration, and then operates in the USB Device mode and conducts subsequent USB data communication with the mobile terminal device 22. In the implementation method, the intelligent storage device 1 may detect the voltage or current on the VBUS signal of the first USB interface 11. When the intelligent storage device 1 is configured to be in the mobile terminal communication mode and the VBUS signal of the first USB interface 11 is connected to the VBUS signal of the second USB interface 12 and when the voltage is lower than a preset voltage value or the current is higher than a preset current value, the intelligent storage device 1 limits the current from the VBUS signal of the first USB interface 11 to the VBUS signal of the second USB interface 12.

In the implementation method, the first USB interface 11 operates in the USB Device mode and attempts to conduct a USB data connection with a device connected to the first USB interface 11, if the connection is successful within a preset time, the first USB interface 11 is connected to the USB host 21, and if the connection is unsuccessful, the first USB interface 11 is connected to the power adapter 21.

In the implementation method, the intelligent storage device 1 further includes a USB interface type detection module 511. The USB interface type detection module 511 detects, according to a Battery Charging Specification, whether a device connected to the first USB interface 11 is a USB host 21 or a power adapter 21.

In the implementation method, when detecting that the device connected to the first USB interface 11 is the power adapter 21, the USB interface type detection module 511 further detects the maximum supply current of the power adapter 21 according to the Battery Charging Specification. When the maximum supply current of the power adapter 21 is lower than a preset value, the intelligent storage device 1 limits the current from the VBUS signal of the first USB interface 11 to the VBUS signal of the second USB interface 12.

In the implementation method, the storage unit interface 54 is an SATA interface, a PCIe interface, an SD (Secure Digital) interface, an MMC (Multimedia Card) interface, a UFS interface, a Toggle NAND Flash interface, an ONFI NAND Flash interface or other storage device interfaces.

In the implementation method, the storage unit 9 may be a mechanical hard disk, a solid-state hard disk, a flash memory chip, a flash memory card, or the like.

According to the intelligent storage device and the method for accessing an intelligent storage device in the present invention, through automatic identification of a connection state of USB interfaces in the intelligent storage device, the intelligent storage device can switch between a PC communication mode and a mobile terminal communication mode, which not only ensures that it can conduct USB data communication with a USB host represented by a PC but also can conduct data communication with a mobile terminal device when it is connected to a mobile phone charger to supply power as a power adapter. In the present invention, a mobile phone charging line, a mobile hard disk USB line, or other common USB cables, are used to be compatible with various types of mobile terminal devices (including android devices and apple IOS devices), and at the same time, with the method of low-voltage detection or over-current detection on a power signal input by the intelligent storage device, the intelligent storage device is controlled to limit or disconnect the power supply to the mobile terminal device, thus ensuring the stability of data transmission when a normal mobile phone charger is used as a power adapter, and improving the compatibility and reliability of the intelligent storage device.

The above are merely preferred embodiments of the present invention, and are not intended to pose any formal limitation to the present invention. The protection scope of the present invention should be subject to the content disclosed in the claims. Any simple change, equivalent replacement or decomposition and combination of the above specific implementations according to the technical essence of the present invention still fall within the protection scope of the technical solution of the present invention.

What is claimed:

1. A method for accessing an intelligent storage device that includes a first USB interface, a second USB interface, and a storage unit interface, wherein
the storage unit interface is connected to a storage unit,
the first USB interface is connected to a USB interface of a USB host or a power adapter through a first USB cable, and a VBUS signal of the first USB interface supplies power for the intelligent storage device and the storage unit,
the intelligent storage device is alternatively configured to be in a PC communication mode or a mobile terminal communication mode according to a connection state of the first USB interface,
the intelligent storage device is configured to be in the PC communication mode when detecting that the first USB interface is connected to the USB host,
in the PC communication mode, the intelligent storage device conducts USB data communication with the USB host through the first USB interface, and reads and writes the storage unit through the storage unit interface, and the first USB interface operates in a USB Device mode,
the intelligent storage device is configured to be in the mobile terminal communication mode when detecting that the first USB interface is connected to the power adapter, and
in the mobile terminal communication mode, the second USB interface is connected to a mobile terminal device through a second USB cable, the intelligent storage device conducts USB data communication with the mobile terminal device through the second USB interface, and reads and writes the storage unit through the storage unit interface.

2. The method for accessing an intelligent storage device according to claim 1, wherein the intelligent storage device disconnects the VBUS signal of the first USB interface from a VBUS signal of the second USB interface when configured to be in the PC communication mode.

3. The method for accessing an intelligent storage device according to claim 1, wherein the intelligent storage device limits a current from the VBUS signal of the first USB interface to the VBUS signal of the second USB interface when configured to be in the PC communication mode.

4. The method for accessing an intelligent storage device according to claim 1, wherein the second USB interface is a USB Type A female connector, and when configured to be in the mobile terminal communication mode, the intelligent storage device connects the VBUS signal of the first USB interface with the VBUS signal of the second USB interface and supplies power for the VBUS signal of the second USB interface, the mobile terminal device conducts USB data communication with the intelligent storage device through the second USB interface, and the second USB interface operates in the USB Host mode.

5. The method for accessing an intelligent storage device according to claim 4, wherein the second USB interface enumerates the mobile terminal device and identifies the type of the mobile terminal device in the USB Host mode, and when the mobile terminal device is identified as an android device, the second USB interface remains in the USB Host mode and conducts subsequent USB data communication.

6. The method for accessing an intelligent storage device according to claim 4, wherein the second USB interface enumerates the mobile terminal device and identifies the type of the mobile terminal device in the USB Host mode, and when the mobile terminal device is identified as an apple IOS Device, the second USB interface performs a role switching operation after enumeration, and then operates in the USB Device mode and conducts subsequent USB data communication with the mobile terminal device.

7. The method for accessing an intelligent storage device according to claim 1, wherein the second USB interface is a USB Type C female connector, the intelligent storage device further includes a PD controller, and when the intelligent storage device is configured to be in the mobile terminal communication mode, the PD controller and the mobile terminal device fixedly configure the second USB interface as a power source through CC1 and CC2 signals of the second USB interface according to a PD protocol, and the intelligent storage device connects the VBUS signal of the first USB interface with the VBUS signal of the second USB interface and supplies power for the VBUS signal of the second USB interface.

8. The method for accessing an intelligent storage device according to claim 1, wherein the second USB interface is a USB Type C female connector, the intelligent storage device further includes a PD controller, and when the intelligent storage device is configured to be in the mobile terminal communication mode, the PD controller and the mobile terminal device negotiate through CC1 and CC2 signals of the second USB interface according to a PD protocol, the intelligent storage device alternatively configures the second USB interface as a power source or a power sink according to a negotiation result, when the second USB interface is configured as the power source, the intelligent storage device connects the VBUS signal of the first USB interface with the VBUS signal of the second USB interface and supplies power for the VBUS signal of the second USB interface, and when the second USB interface is configured as the power sink, the intelligent storage device disconnects the VBUS signal of the first USB interface from the VBUS signal of the second USB interface.

9. The method for accessing an intelligent storage device according to claim 1, wherein the second USB interface is a USB Type C female connector, the intelligent storage device further includes a PD controller, and when the intelligent storage device is configured to be in the mobile terminal communication mode, the PD controller and the mobile terminal device fixedly configure the second USB interface to be in a USB host mode through CC1 and CC2 signals of the second USB interface according to a PD protocol and conduct USB data communication with the mobile terminal device.

10. The method for accessing an intelligent storage device according to claim 9, wherein the second USB interface enumerates the mobile terminal device and identifies the type of the mobile terminal device in the USB Host mode, and when the mobile terminal device is identified as an android device, the second USB interface remains in the USB Host mode and conducts subsequent USB data communication with the mobile terminal device.

11. The method for accessing an intelligent storage device according to claim 9, wherein the second USB interface enumerates the mobile terminal device and identifies the type of the mobile terminal device in the USB Host mode, and when the mobile terminal device is identified as an apple IOS Device, the second USB interface performs a role switching operation after enumeration, and then operates in the USB Device mode and conducts subsequent USB data communication with the mobile terminal device.

12. The method for accessing an intelligent storage device according to claim 1, wherein the second USB interface is a USB Type C female connector, the intelligent storage device further includes a PD controller, and when the intelligent storage device is configured to be in the mobile terminal communication mode, the PD controller and the mobile terminal device negotiate through CC1 and CC2 signals of the second USB interface according to a PD protocol, and the intelligent storage device alternatively configures the second USB interface to be in a USB Host mode or USB Device mode according to a negotiation result and conduct USB data communication with the mobile terminal device.

13. The method for accessing an intelligent storage device according to claim 12, wherein when the second USB interface is configured to be in the USB Host mode, the second USB interface enumerates the mobile terminal device and identifies the type of the mobile terminal device in the USB Host mode, and when the mobile terminal device is identified as an android device, the second USB interface remains in the USB Host mode and conducts subsequent USB data communication with the mobile terminal device.

14. The method for accessing an intelligent storage device according to claim 12, wherein when the second USB interface is configured to be in the USB Host mode, the second USB interface enumerates the mobile terminal device and identifies the type of the mobile terminal device in the USB Host mode, and when the mobile terminal device is identified as an apple IOS Device, the second USB interface performs a role switching operation after enumeration, and then operates in the USB Device mode and conducts subsequent USB data communication with the mobile terminal device.

15. The method for accessing an intelligent storage device according to claim 1, wherein the intelligent storage device detects the voltage of the VBUS signal of the first USB interface, and when the intelligent storage device is configured to be in the mobile terminal communication mode and the VBUS signal of the first USB interface is connected to the VBUS signal of the second USB interface, the intelligent storage device limits the current from the first USB interface to the VBUS signal of the second USB interface if the voltage is lower than a preset voltage value.

16. The method for accessing an intelligent storage device according to claim 1, wherein the intelligent storage device detects the current of the VBUS signal of the first USB interface, and when the intelligent storage device is configured to be in the mobile terminal communication mode and the VBUS signal of the first USB interface is connected to the VBUS signal of the second USB interface, the intelligent storage device limits the current from the first USB interface to the VBUS signal of the second USB interface if the current is higher than a preset current value.

17. The method for accessing an intelligent storage device according to claim 1, wherein the first USB interface operates in the USB Device mode and attempts to conduct a USB data connection with a device connected to the first USB interface, if the connection is successful within a preset time, the first USB interface is connected to the USB host, and if the connection is unsuccessful, the first USB interface is connected to the power adapter.

18. The method for accessing an intelligent storage device according to claim 1, wherein the intelligent storage device further includes a USB interface type detection module that detects, according to a Battery Charging Specification, whether the device connected to the first USB interface is a USB host or a power adapter.

19. The method for accessing an intelligent storage device according to claim 18, wherein when detecting that the device connected to the first USB interface is the power adapter, the USB interface type detection module further detects a maximum supply current of the power adapter according to the Battery Charging Specification, and when the maximum supply current of the power adapter is lower than a preset value, the intelligent storage device limits the current from the VBUS signal of the first USB interface to the VBUS signal of the second USB interface.

20. The method for accessing an intelligent storage device according to claim 1, wherein the storage unit interface is an SATA interface, a PCIe interface, an SD interface, an MMC interface, a UFS interface, a Toggle NAND Flash interface, or an ONFI NAND Flash interface.

21. The method for accessing an intelligent storage device according to claim 1, wherein the first USB interface is a USB Micro B female connector or USB Type C female connector.
